(19) United States
(12) Patent Application Publication
(10) Pub. No.: US 2025/0048999 A1
(43) Pub. Date: Feb. 13, 2025

(54) Dispensing Collar

(71) Applicant: Patrick Selsted, Pasadena, CA (US)

(72) Inventor: Patrick Selsted, Pasadena, CA (US)

(21) Appl. No.: 18/797,208

(22) Filed: Aug. 7, 2024

Related U.S. Application Data
(63) Continuation of application No. 63/531,438, filed on Aug. 8, 2023.

(51) Int. Cl. A01K 27/00; A01K 5/02; A01K 15/02

(52) U.S. Cl. CPC A01K 27/006; A01K 27/001; A01K 5/0291; A01K 15/021

(57) ABSTRACT

An animal collar stores and dispenses food, medications and/or other items, preferably to the animal wearing the collar. Dispensing can be triggered based on time (e.g., every 4 hours, etc.), electronic, voice or other signal.

### PRIORITY

This application claims priority to U.S. provisional application Ser. No. 63/531,438 filed Aug. 8, 2023.

### FIELD OF THE INVENTION

The field of the invention is a collar, and more particularly, a dispensing collar for an animal.

### BACKGROUND

The background description includes information that may be useful in understanding the present invention. It is not an admission that any of the information provided herein is prior art or relevant to the presently claimed invention, or that any publication specifically or implicitly referenced is prior art.

An animal collar is an important tool that is used by animal handlers for a variety of reasons. There are many types of animal collars that each serve a specific purpose. For example, an animal collar can simply be used to mount an identification or medical tag onto an animal and/or to control an animal either directly by grabbing the animal collar or indirectly via a leash attached to the animal collar. Animal collars can also be designed to aid in training. For example, U.S. Pat. No. 7,644,685 (Groh et at.) discloses collars that provide electrical stimulation and non-electrical stimulation (e.g., vibrations, spray deterrent) for training a pet. Animal collars having a storage component have also been disclosed. For example, U.S. Patent Publication No. 2008/0276876 (Hill) discloses an accessory for a dog collar that comprises a first compartment that can be filled with water and a second compartment that can be used to store dry goods.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, although a variety of animal collars exist, there is still a need in the art for improved animal collars.

### SUMMARY OF THE INVENTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Also, as used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The inventive subject matter provides apparatus, systems, and methods in which an animal collar can be used to store and dispense items to an animal for a variety of purposes. The items that contemplated animal collars can store and dispense range from animal treats to medications. For example, contemplated animal collars can store animal treats, which can be dispensed remotely by an animal owner or caretaker to reward good behavior. In another example, contemplated animal collars can store doses of medication or animal food containing medication, which can be dispensed based on time (e.g., every 4 hours, etc.). Thus, multi-purpose animal collars are contemplated that can conveniently store and dispense items to an animal.

### BRIEF DESCRIPTION OF THE DRAWING

FIG. 1 is a horizontal cross-section of an embodiment of an animal collar.

FIG. 2 is a perspective view of the collar of FIG. 1 in which the dispensing unit is in a closed position.

FIG. 3 is a perspective view of the collar of FIG. 1 in which the dispensing unit is in an open position.

FIG. 4 is a horizontal cross-section of an alternative embodiment of an animal collar.

### DETAILED DESCRIPTION

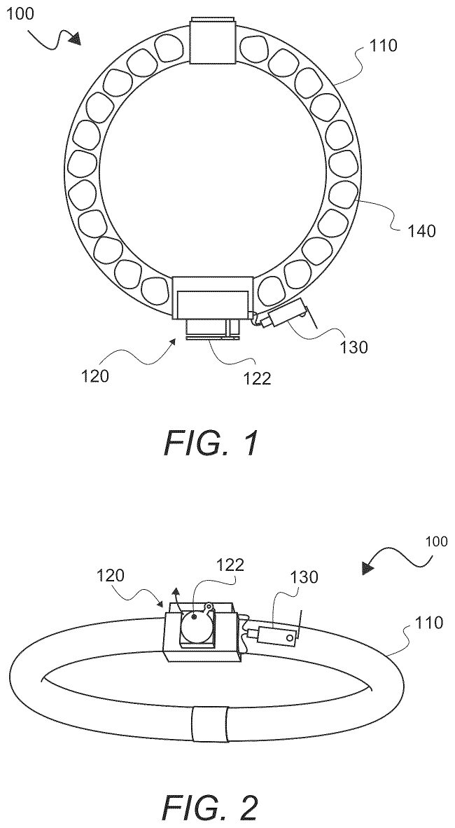

FIG. 1 is a horizontal cross-section of an embodiment of an animal collar 100. In this embodiment animal collar 100 comprises a strap 110 and a dispensing unit 120. Strap 110 comprises an internal chamber that is sized and dimensioned to store one or more items 140. It is contemplated that the one or more items 140 are one or more of animal treats, medication, animal food, and animal food or treats containing medication. Animal collar 100 further comprises electronics 130 that allow a user to remotely cause dispensing unit 120 to dispense one item 140 stored within strap 110. Additionally, or alternatively, electronics 130 can be programmed to dispense one item 140 stored within strap 110 based on time (e.g., every hour) and/or location (e.g., proximity to area within house or ranch).

Strap 110 is shown in FIG. 1 to hold items 140 within an internal chamber that spans across the length of strap 110. However, it is contemplated that the internal chamber can span across only a portion of the length of strap 110. Strap 110 is tubular having a lumen that defines the internal chamber. It is contemplated that strap 110 is sized and dimensioned to fit around the neck of the animal. Strap 110 can be adjustable (e.g., a strap having a plastic or metal buckle that engages one of several holes along the strap to adjust the length of the strap around the neck of an animal) or a fixed length.

As discussed above, the one or more items 140 can be one or more of animal treats, medication, animal food, and animal food or treats containing medication. It is contemplated that the one or more items 140 have a circular cross-sectional area (e.g., cylindrically-shaped, spherically-shaped, etc.) that thereby allow the one or more items 140 to roll within the internal chamber via gravity to dispensing unit 120. For example, a first item can be dispensed through dispensing unit 120 which thereby causes the remaining items within the internal chamber of strap 110 to roll and position a second item within dispensing unit 120 for dispensing.

It is contemplated that the one or more items 140 can be loaded into the internal chamber of strap 110 through an end of strap 110 that is removably coupled to dispensing unit 120. Additionally, or alternatively, strap 110 can comprise a first strap portion that is removably coupled to a second strap portion, such that an opening into the first strap portion and/or an opening into the second strap portion is accessible for loading the one or more items when the portions are uncoupled. In other embodiments, strap 110 is pre-loaded with items 140 in the internal chamber and strap 110 is fixed to dispensing unit 120 so as to not allow loading of additional items into the internal chamber.

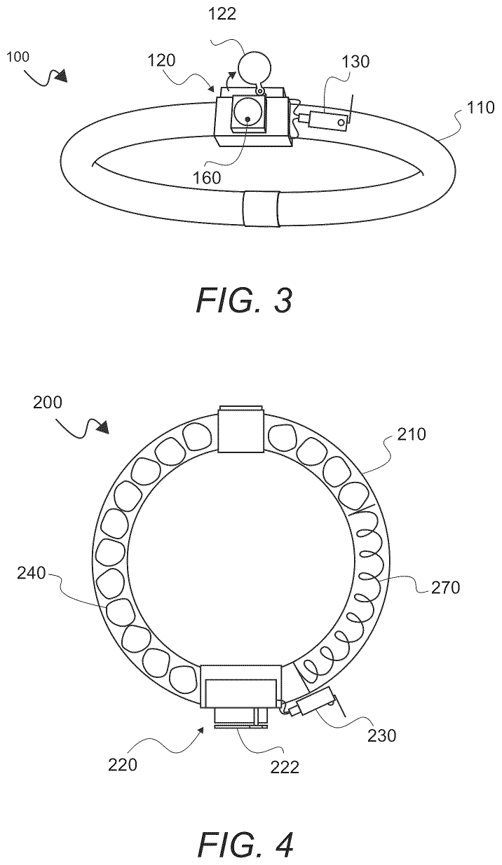

As discussed above, the one or more items 140 are dispensed through dispensing unit 120. Dispensing unit 120 has a closed position shown in FIG. 2 and an open position shown in FIG. 3. As shown in FIGS. 2-3, dispensing unit 120 comprises a housing having a cover 122 and an outlet 160. Cover 122 is configured to cover outlet 160 in the closed position and uncover outlet 160 in the open position. When animal collar 100 is worn by an animal, it is contemplated that dispensing unit 120 is positioned at the front of the neck, such that animal collar 100 is angled downward from the rear end (end opposite of dispensing unit 120) to dispensing unit 120 to thereby cause an item 140 within dispending unit 120 to exit through outlet 160 when uncovered. The item 140 (e.g., animal treat, animal food, medication, etc.) can then be consumed by the animal wearing animal collar 100.

Electronics 130 is configured to receive a signal and cause cover 122 to cover or uncover outlet 160 based on the signal. For example, electronics 130 can comprise (1) a receiver configured to receive the signal, (2) an actuator configured to cause cover 122 to cover or uncover outlet 160, and (3) a controller coupled to the receiver and actuator, and configured to receive the signal from the receiver and actuate the actuator based on the signal to cover or uncover 160 outlet. It is contemplated that the signal is one or more of a Wi-Fi signal, a Bluetooth signal, and an infrared signal. For example, an animal owner or caretaker can dispense an item 140 in animal collar 100 using an electronic device (e.g., a mobile phone, a tablet, a computer, a remote controller, etc.) to send a signal over Wi-Fi, Bluetooth, or infrared to electronics 130 to thereby cause cover 122 to uncover outlet 160 for the item 140 to be dispensed to the animal.

It is also contemplated that electronics 130 can be programmed to cause cover 122 to cover and uncover outlet 160 based on time and/or location. For example, an animal owner or caretaker can program electronics 130 to cause cover 122 to uncover outlet 160 and dispense an item 140 at a specific time of the day (e.g., 12 pm, 1 pm, etc.), at specific time intervals (e.g., every 2 hours, 3 hours, etc.), and/or after a specific time has passed (e.g., dispense in 30 minutes, 1 hour, 2 hours, etc.). Additionally, or alternatively, an animal owner or caretaker can program electronics 130 to cause cover 122 to uncover outlet 160 and dispense an item 140 when animal collar 100 is detected at a location (e.g., at a specific house, at a specific ranch, etc.) or an area within a location (e.g., a back yard of a house, a front yard of a house, etc.).

FIG. 4 shows another embodiment of an animal collar 200. Animal collar 200 has many of the same components of animal collar 100, such as a strap 210, electronics 230, and a dispensing unit 220 comprising a cover 222 and an outlet (not shown). Strap 210 comprises an internal chamber for storing one or more items 240. It is contemplated that the one or more items 240 are one or more of animal treats, medication, animal food, and animal food or treats containing medication.

Animal collar 200 further comprises a spring 270 within the internal chamber of strap 210. Spring 270 is configured to bias the one or more items 240 towards dispensing unit 220. Once an item is dispensed, spring 270 biases the one or more items 240 to position another item within dispensing unit 220 for dispensing.

It is contemplated that the one or more items 240 can be loaded into the internal chamber of strap 210 through an end of strap 210 that is removably coupled to dispensing unit 220. Additionally, or alternatively, strap 210 can comprise a first strap portion that is removably coupled to a second strap portion, such that an opening into the first strap portion and/or an opening into the second strap portion is accessible for loading the one or more items when the portions are uncoupled. In other embodiments, strap 210 is pre-loaded with items 240 in the internal chamber and strap 210 is fixed to dispensing unit 220 so as to not allow loading of additional items into the internal chamber.

Thus, it should be appreciated that contemplated animal collars can be used as a training tool for animals. An animal owner or caretaker can remotely dispense animal treats or food to an animal wearing the animal collar based on good behavior. Additionally, contemplated animal collars can be used to treat animals having an illness. An animal owner or caretaker can remotely dispense medication or animal food or treats containing medication at a certain time or at time intervals.

It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. An animal collar that dispenses one or more items, comprising:
a strap having an internal chamber sized and dimensioned to store the one or more items;
a dispensing unit coupled to the strap; and
wherein the dispensing unit is configured to receive and dispense the one or more items.

2. The animal collar of claim 1, wherein the dispensing unit comprises a housing having an outlet.

3. The animal collar of claim 2, wherein the dispensing unit comprises a cover configured to cover and uncover the outlet.

4. The animal collar of claim 3, wherein the dispensing unit comprises electronics configured to receive a signal and cause the cover to cover or uncover the outlet.

5. The animal collar of claim 4, wherein the electronics comprise (1) a receiver configured to receive the signal, (2) an actuator configured to cause the cover to cover or uncover the outlet, and (3) a controller coupled to the receiver and actuator, and configured to receive the signal from the receiver and actuate the actuator based on the signal to cover or uncover the outlet.

6. The animal collar of claim 4, wherein the electronics are further configured to cause the cover to cover or uncover the outlet based on time.

7. The animal collar of claim 2, further comprising a spring within the internal chamber, wherein the spring is configured to bias the one or more items toward the outlet.

8. The animal collar of claim 1, wherein the strap is tubular having a lumen that defines the internal chamber.

9. The animal collar of claim 7, further comprising a spring within the internal chamber, wherein the spring is configured to bias the one or more items toward the dispensing unit.
